(19) United States
(12) Patent Application Publication
(10) Pub. No.: US 2011/0030232 A1
(43) Pub. Date: Feb. 10, 2011

(54) BINARY FLUID EJECTOR DESICCATION SYSTEM AND METHOD OF UTILIZING THE SAME

(76) Inventor: Wayne A. May, Las Vegas, NV (US)

Correspondence Address: GREENBERG TRAURIG (LV), 3773 HOWARD HUGHES PARKWAY, Suite 400 North, LAS VEGAS, NV, 89169, US

(21) Appl. No.: 12/846,659

(22) Filed: Jul. 29, 2010

Related U.S. Application Data
(60) Provisional application No. 61/230,642, filed on Jul. 31, 2009.

(51) Int. Cl. F26B 21/06

(52) U.S. Cl. 34/73

(57) ABSTRACT

A thermal cycle and mass flow circuit designed for the purpose of drying materials. Binary fluid ejector desiccation represents a new thermodynamic bi-cycle in the field of desiccation (drying). The binary fluid ejector desiccation comprises binary-fluid ejector gas-phase fluid compression and transport, a thermodynamic cycle where phase change energy from the evaporation process is captured, re-circulated and reused as an energy source for the evaporation process itself, and for one method of use, a mass flow circuit that exploits the fluid constituents from the desiccating material as the refrigerant component of the binary working fluid. Methods of use are taught where direct or indirect heat transfer occurs between the working fluid(s) and the material being desiccated.

### CROSS-REFERENCE TO RELATED APPLICATIONS

This application claims the benefit of U.S. Provisional Patent Application No. 61,230,642 filed on Jul. 31, 2009 which is incorporated herein by reference in its entirety.

### FIELD OF THE INVENTION

The embodiments of the present invention relate to drying materials with thermal energy and mass transport. The embodiments of the present invention particularly relate to using low grade and/or low temperature input thermal energy, such as that generated by flue gas, engine exhaust, solar radiation, process waste heat or geothermal sources, to affect such drying, as well as using the same as the motive energy for the operation of the machine itself. The embodiments of the present invention further relate to the capture, recirculation and reuse of phase change energy absorbed by the liquids evaporated from materials as an energy source for the evaporation process itself.

### BACKGROUND

Many mixed phase materials are thermally dried in manufacturing, industrial and agricultural processes. The pre-dried nature of these materials range from liquid, slurry, mud and paste comprising a rheologic continuum largely controlled by particle size of the solids and liquid-solid content ratio to materials containing a substantially lower liquid fraction that are simply considered moist. Examples of the former broad range of materials include milk, coffee, tea and other products on the liquid end of the continuum to a huge number of mining and mine production wastes such as oils ands tailings, coal fine slurries, phosphate mine tailings and a host of other waste slurries including muds and pastes from mining, drilling and manufacturing processes such as paper pulp production. Examples of the latter range of so-called moist materials include nearly every harvested field crop from potatoes to peanuts, including wheat, corn, rice, beans, peas, lentils, legumes, seed and many others. Nearly every type of cultivated food is dried at least once from the time it is harvested to its end use. Moist commercial and industrial products that are dried include materials like cement, wood chips, municipal human and farm animal waste, animal feed such as hay and alfalfa, gravel and sand, and many ceramic materials such as brick, tile and concrete block. The embodiments of the present invention can be effectively applied to any of these materials for the purpose of thermal or evaporative drying.

There exist a large number of drying machine types consistent with the large number and diverse types of materials and products which need to be thermally dried. These diverse thermal or evaporative drying machines, systems and methods can be categorized or classified according to a number of different criteria. For example, evaporative driers are often classified as cross flow or counter flow, referring to the flow direction of the heat transfer fluid, usually air, with respect to the flow direction of the material being dried. Material handling classifications include continuous sheet feed (paper, textiles, etc.), spray, rotary drum, fluidized bed, auger, bin, batch and many others, referring to the method by which the material being dried is managed through the dryer. Yet another basis for classifying or categorizing thermal dryers is by heat source and/or method of applying the heat required for evaporation. These machine types include natural air (i.e., ambient air), combusted fuel heated air, by far the largest group, direct and indirect solar radiation, electric resistance heating, microwave, infrared, induction or dielectric heating, heat pump drying and vapor recompression evaporation. Heat pump, vacuum pump, vapor compression and recompression evaporation type dryers are also often classified according to the type of compression employed, such as reciprocal or screw compressor, compression turbine, fan or blower. Still other classifications pertain to the temperature and/or pressure conditions under which the drying takes place, so called vacuum and low temperature drying for example. Regardless of these distinctions, the machines, systems and methods of the prior art are corralled by the physics of evaporative drying into a single group fundamentally bound by a thermodynamic cycle common to all. One aspect taught by the embodiments of the present invention is a unique thermodynamic cycle, the advantages of which will be readily appreciated by those skilled in the relevant art.

The thermodynamic cycle, common to evaporative dryers, may be generally characterized as consisting of a heat source, a heat exchange process and a heat sink. The heat source provides the energy for evaporation; the heat exchange conveys the energy to the material being dried; and the heat sink absorbs or otherwise exhausts the heat energy. The systems must also have a mass transport means to separate and remove the gas or vapor evaporated from the material being dried. Relating to the heat exchange process, there are three typical methods of evaporative drying that are distinguished by the heat transfer fluid and the mass flow circuit thereof: 1) direct-contact heated air evaporation, 2) direct-contact heat pump evaporation, and 3) indirect-contact vapor recompression evaporation (also known as vapor compression evaporation). Methods 1) and 2) employ a heat transfer fluid, usually air, brought into direct contact with the material being dried, hence the nomenclature “direct-contact.” Method 3) employs the gases and/or vapors evaporated from the material being dried as the heat transfer fluid. Heat is exchanged with the material being dried by means of a heat exchanger, hence the nomenclature“indirect-contact” heat transfer.

Direct-contact heated air evaporation is by far the most common type of evaporative drying. Such methods, processes, machines and systems employ a heat transfer fluid, usually air, brought into direct contact with the material being dried. The heat transfer fluid is first heated, circulated through, over or around the material being dried, whereupon heat is transferred and liquid is evaporated. The moisture-laden heat transfer fluid is usually exhausted to the atmosphere (in some designs, a portion of the moisture-laden transfer fluid is re-circulated through the burner or heater). The method of heating the heat transfer fluid is immaterial, but burning a fuel such as propane is well known. In some circumstances, the material being dried is direly heated by means of infrared, microwave or inductive heating. These type of systems are generally referred to as hot-air or heated-air dryers, and are employed throughout the entire range of commercial, industrial, pharmaceutical and agricultural drying applications. The embodiments of the present invention are well-suited for any of the aforementioned applications and can replace any such traditional dryer with a system comprising fewer moving parts, higher energy efficiency and a lower carbon footprint (i.e., less environmental impact in terms of atmospheric carbon generation).

The second method relating to the heat transfer fluid or the mass flow circuit thereof is direct-contact heat pump evaporation. In this case, a heat transfer fluid is brought into direct contact with the material being dried, again usually air, but the fluid is not heated by burning a fuel or by other means, nor is it exhausted to atmosphere; instead, it is re-circulated through a refrigeration cycle. Warm moist heat transfer fluid is exhausted by fan or blower from the material being dried, and then made to flow through a refrigerated heat exchanger, sometimes the evaporator of the refrigeration system itself. The temperature of the heat transfer fluid is lowered below the dew point of the evaporated gas or vapor whereupon it condenses. Separation and extraction is usually by gravity flow. The cool dry heat transfer fluid is then made to flow through a high temperature heat exchanger, again, sometimes the condenser of the refrigeration system itself. The dry heat transfer fluid is heated therein and then made to flow back to the material being dried to complete the circuit. This type of system is generally cost effective for a limited number of applications, such as those that require low temperature drying, heat sensitive pharmaceuticals and some high performance ceramics for example. The embodiments of the present invention are well suited for any of the aforementioned applications and can replace any such traditional dryer with a system comprising fewer moving parts, higher energy efficiency and a lower carbon footprint (i.e., less environmental impact in terms of atmospheric carbon generation).

The third method of evaporative drying having a common thermodynamic cycle but distinguished by its heat transfer fluid or mass flow circuit thereof is mechanical vapor recompression evaporation. In this case, energy for evaporation is conveyed to the material being dried through a heat exchanger which physically isolates the material from the heat transfer fluid; hence the nomenclature “indirect-contact” heat transfer. Further, the heat transfer fluid employed is the gas or vapor evaporating from the material being dried. A mechanical compressor lowers the pressure over the material being dried below the vapor pressure of the liquid being evaporated. The evaporated gases and vapors are conveyed and compressed, and then made to flow through the condensing side of the heat exchanger. As the gases and vapors condense, heat energy for evaporation is transferred to the material being dried through the walls of the heat exchanger. Hence, the heat exchanger is condensing evaporated gas on one side, and boiling or evaporating the subject liquid on the other side. Despite the fact that dryers employing mechanical vapor compression evaporation are more energy efficient than other drying methods, they are not widely used due to high capital cost, high system complexity and the need for high grade input energy in the form of grid electricity. By contrast, the energy efficiency of the embodiments of the present invention is equal to or greater than these conventional systems and methods, while having a lower capital cost, fewer moving parts and lower system complexity, as well as the capacity to be powered by low grade input energy.

The embodiments of the present invention offer certain advantages over that of conventional drying methods and systems for at least the following exsiccation, desiccation, or inspissation (thickening) applications: 1) post harvest foods such as grains, beans, legumes, tubers, roots, seeds, nuts, etc.; 2) other foods such as tea, coffee beans, berries, fruits, and vegetables; 3) pre-production food such as flour, corn meal, etc.; 4) animal feed such as hay, alfalfa, soybeans, clover, grass, etc.; 5) mining and drilling waste tailing slurries, muds, and pastes; 6) mineral extraction and production waste slurries, muds, and pastes; 7) farm animal waste slurries and sludge; 8) municipal human waste slurries and sludge; 9) wood timber and cut wood; 10) paper pulp, paper, wood chips, textiles, and other fibers; 11) production tile, brick, pottery and other ceramic or refractory products; and 12) pharmaceuticals.

### SUMMARY

The embodiments of the present invention involve binary fluid ejector compression and fluid mass transport configured in a unique thermodynamic bi-cycle employing new and heretofore unexploited operating principles for the purpose of thermally drying materials. A binary fluid ejector is a gas-phase direct energy transfer pump that uses a high pressure primary fluid jet oscillating in the spatial domain as a means to entrain, mix, compress and transport a low pressure secondary fluid serving as both a refrigerant and a source of heat energy for the evaporation process itself.

Traditional thermal evaporative drying processes, methods, machines and systems normally function by means of a common thermodynamic cycle characterized by a heat source providing energy for evaporation, a heat exchange process conveying this energy to the material being dried, and a heat sink absorbing or otherwise disposing of the heat. In all cases, one of two mass flow techniques are employed for the purpose of heat transfer (i.e., “direct-contact” and “indirect-contact” heat transfer). Direct-contact heat transfer means that the heat transfer fluid is brought into direct, intimate contact with the material being dried as a means to supply energy for evaporation. Indirect-contact heat transfer means that the heat transfer fluid is isolated from the material being dried by a heat exchanger whereby energy for evaporation is transferred through the walls of said heat exchanger. In either case, the thermal cycle responsible for evaporation is the same. By contrast, the embodiments of the present invention utilize a unique thermodynamic bi-cycle for the purpose of thermal evaporative drying. Instead of one thermal cycle, the embodiments of the present invention employ two thermodynamic cycles including one consistent with the thermal dynamics of evaporative drying, and the other consistent with the thermodynamics of a binary fluid ejector refrigeration cycle. The two thermal cycles are intimately joined by a mass flow circuit equilibrated by the binary fluid ejector. Those skilled in the relevant art will appreciate the novel design of the embodiments of the present invention by the descriptions and drawings presented herein.

With one method of use according to the embodiments of the present invention, a system is configured similar to direct-contact heat pump evaporation system, where heated air or another suitable heat transfer fluid is circulated over, around or through a material to be dried. The moisture-laden, heat-transfer fluid is then made to flow through a first heat exchanger and is cooled by action of the binary fluid ejector refrigeration cycle. The first heat exchanger may be the evaporator of the ejector refrigeration cycle. Heat energy is absorbed by the heat exchanger thus cooling the heat transfer fluid and condensing the evaporated gases and vapors therefrom. The liquid fraction or condensate is then removed from the system by means of gravity draining or a pump. The cool dry heat-transfer fluid is then conveyed by a fan or blower to a second heat exchanger where it is heated and returned to the material being dried, thereby providing heat energy for evaporation and completing the cycle. The second heat exchanger may be the condenser of the ejector refrigeration cycle. For the purpose of this disclosure, this method of use is termed “direct-contact” binary fluid ejector desiccation, referring to the condition where the heat transfer fluid is brought into intimate contact with the material being dried for the purpose of heat transfer and evaporation.

With a second method of use according to the embodiments of the present invention, a system is configured similar to an indirect-contact vapor recompression evaporation system, where the gases and vapors evaporating from the material being dried are ingested by the binary fluid ejector, thereby becoming the secondary fluid constituent of the working binary fluid. Heat transfer to the material being dried is accomplished by means of a heat exchanger that isolates the drying material from the heat transfer fluid, which in this case is the fluid evaporating from the material being dried. The binary fluid ejector of the embodiments of the present invention lowers the pressure over the material being dried below the vapor pressure of the subject liquid, thus causing low temperature, low pressure evaporation. The evaporated gases are ingested, entrained, mixed, compressed and transported by the binary fluid ejector, and then conveyed back to the heat exchanger. The compressed gas is adiabatically heated by the ejector, as well as being heated by mixing with the high pressure high temperature primary drive fluid, to a temperature higher than the material being dried. Both sensible and phase change heat are transferred through the walls of the heat exchanger thereby providing heat energy for evaporation. Since the phase change enthalpy of the evaporated gases and vapors is transferred through the walls of the heat exchanger, they are condensed into liquid phase along with the primary drive fluid. Hence, one side of the heat exchanger functions as a condenser, while the other side functions as an evaporator. The binary fluid condensate is then fractionated and separated. The secondary fluid condensate is gravity drained or pumped from the system, while the primary drive fluid condensate is returned to the boiler for reuse driving the ejector, thus completing the cycle. For the purpose of this disclosure, this method of use is termed “indirect-contact” binary fluid ejector desiccation, referring to the condition where the heat transfer fluid is physically isolated from the material being dried and heat transfer occurs through the walls of a heat exchanger serving the dual function of evaporator and condenser.

As will be demonstrated in the following drawings and detailed descriptions, both of the methods of use (i.e. direct-contact binary fluid ejector desiccation and indirect-contact binary fluid ejector desiccation) comprise the same thermodynamic cycle as it relates to the thermal evaporation of a liquid from a material. While both methods of use comprise thermal evaporative drying by means of binary fluid ejector refrigeration, the direct-contact method proceeds at near zero differential pressure, whereas the indirect-contact method proceeds at a somewhat elevated differential pressure. Differential pressure in this context refers to the difference in pressure between the evaporating environment versus the condensing environment, that is, the pressure above the material being dried in the dryer versus the pressure above the subject evaporate condensing in the condenser. The direct-contact method of use employs a heat transfer fluid which is separate and distinct from the gas and/or vapor evaporating from the material being dried, usually air, while the indirect-contact method employs the gas and/or vapor evaporating from the material being dried as the heat transfer fluid.

Other variations, embodiments and features of the present invention will become evident from the following detailed description, drawings and claims.

### BRIEF DESCRIPTION OF THE DRAWINGS

FIGS. 1.a-1.c illustrate prior art evaporative drying systems depicting heat transfer fluid circuits for direct-contact heated-air, direct-contact heat pump and indirect-contact mechanical vapor recompression evaporative drying methods, respectively;

FIGS. 2.a and 2.b illustrate temperature versus entropy diagram (T-s) depicting the thermodynamic cycle common to direct-contact heated air and direct-contact heat pump evaporative drying processes and indirect-contact vapor compression evaporative drying processes, respectively, of the prior art;

FIG. 3 illustrates a binary fluid ejector desiccation system (direct contact) according to the embodiments of the present invention;

FIG. 4 illustrates a binary fluid ejector desiccation system (indirect contact) according to the embodiments of the present invention; and

FIGS. 5.a and 5.b illustrate entropy/temperature diagrams associated with the binary fluid ejector desiccation systems according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

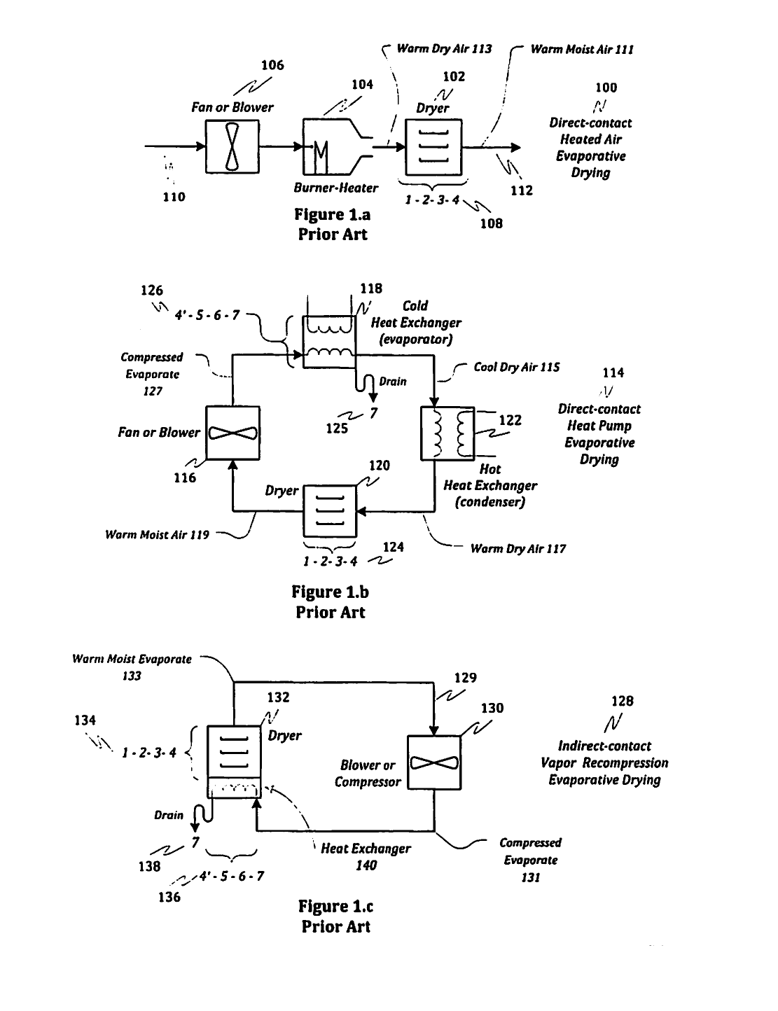

FIGS. 1.a, 1.b, and 1.c depict the heat transfer fluid circuits for direct-contact heated-air, direct-contact heat pump and indirect-contact mechanical vapor recompression evaporative drying methods taught by the prior art. Air is shown as the heat transfer fluid in FIGS. 1.a and 1.b, however, any fluid may serve this function. Heat transfer for the circuit depicted in FIG. 1.c is accomplished indirectly by means of a heat exchanger serving the dual role of evaporator and condenser. The heat transfer fluid in this case is the subject evaporate itself. Arrows indicate the direction and ordering of fluid flow. These three methods of thermal evaporative drying are shown as an aid to understanding the embodiments of the present invention.

FIG. 1.a is a simplified mass flow diagram of direct-contact heated-air evaporative drying system 100. Ambient air 110 is drawn into the system by a fan or other suitable device 106 and then conveyed to a burner or other type of heater 104. The method of heating the heat transfer fluid is immaterial to this exam. Ambient air 110 is heated in the heater 104 and then conveyed to a dryer 102 where it is brought into direct contact with the material being dried. Warm dry air 113 from the heater 104 is used as an energy source for evaporating the subject liquid from the material being dried. Generally, the warm moist air 111 exiting the dryer 102 is vented to atmosphere 112, although in some cases a portion of the warm moist air 111 exiting the dryer 102 is re-circulated (not shown) through the heater 104. The reference numerals “1-2-3-4” 108 are discussed below.

FIG. 1.b is a simplified mass flow diagram of direct-contact heat pump evaporative drying system 114. Cool dry air 115 from the cold heat exchanger 118 is conveyed to a hot heat exchanger 122 by a fan or other suitable device 116. Cool dry air 115 is heated in the hot heat exchanger 122 and then conveyed to the dryer 120 as warm dry air 117. The hot heat exchanger 122 may be the condenser of the heat pump, or a tertiary heat exchanger. The heat pump circuit is not shown. Heated dry air 117 is brought into direct contact with the material being dried in the drier 120 which supplies the energy required for evaporating the subject liquid. The reference numerals “1-2-3-4” 124 are discussed below. Warm moist air 119 exits the drier 120 and is conveyed to a cold heat exchanger 118. The cold heat exchanger 118 may be the evaporator of the heat pump, or a tertiary heat exchanger. The heat pump circuit is not shown. The reference numerals “4-5-6-7” 126 are discussed below. Warm moist air 119 is adiabatically compressed by fan 116 making a compressed evaporate 127. Compressed evaporate 127 from fan 116 is cooled to a temperature below its dew point by the cold heat exchanger 118, whereupon the subject evaporate condenses to liquid phase and is drained or pumped (not shown) from the system as condensate 125. The reference numeral “7” 125 is discussed below.

FIG. 1.c is a simplified mass flow diagram of an indirect-contact vapor recompression evaporative drying system 128. The blower, compressor or other suitable device 130 lowers the gas pressure over the material being dried in the dryer 132 below the vapor pressure of the subject liquid being evaporated. The reference numerals “1-2-3-4” 134 are discussed below. Warm moist evaporate 133 exiting the dryer 132 is compressed and conveyed to the heat exchanger 140 by the compressor or other suitable device 130. The reference numerals“4′-5-6-7” 136 are discussed below. Adiabatic compression and waste heat absorption raise the temperature of the compressed evaporate 131 above the temperature of the warm moist evaporate 133 exiting the dryer 132. The compressed evaporate 131 is isolated from the material being dried in the dryer 132 by the wall or walls of the heat exchanger 140; a heat transfer coil immersed in a slurry being dried for example. Heat energy is transferred from the compressed evaporate 131 to the material being dried in the dryer 132 thus supplying the energy required for evaporation of the subject liquid. The evaporate is in turn cooled by the evaporating subject liquid, and thereby condenses back to liquid phase 138. The heat exchanger 140 serves the dual role of condenser and evaporator. This liquid condensate 138 is removed from the system by gravity drain 138 or pump (not shown). The reference numeral “7” 138 is discussed below.

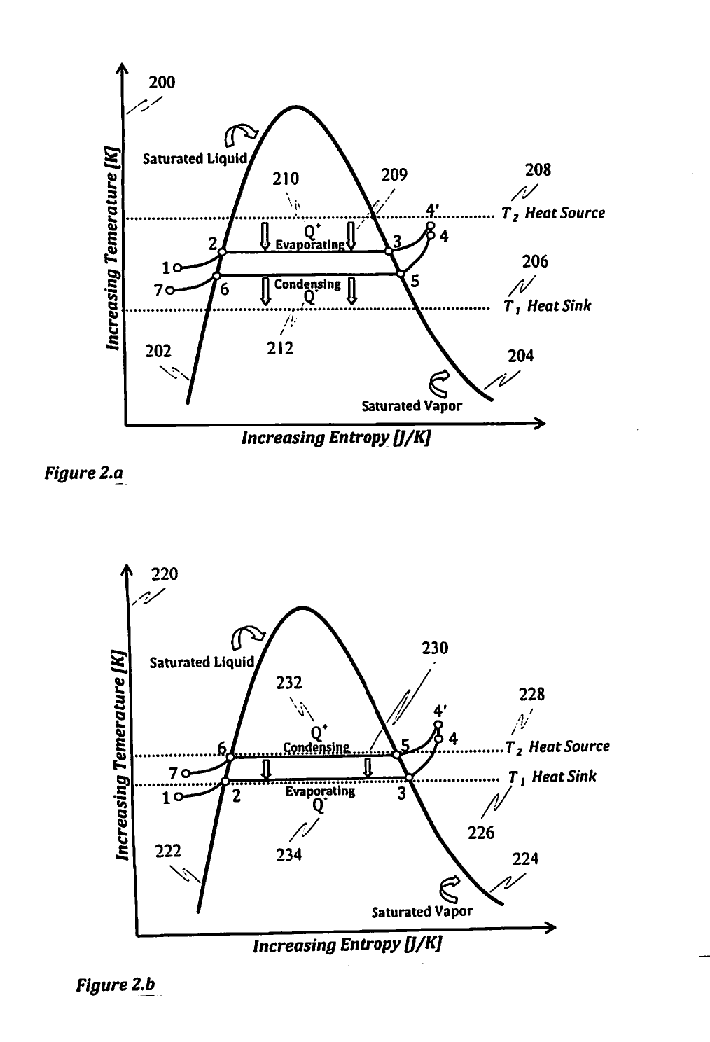

In the context of the embodiments of the present invention, there is an important distinction to be understood concerning the three methods of evaporative drying presented in FIGS. 1.a, 1.b, and 1.c that pertain to the relationship between the heat transfer fluid employed by the system and the gas and/or vapor being evaporated from the material being dried. For direct-contact heated air 100 and direct-contact heat pump 114 evaporative drying depicted in FIGS. 1.a and 1.b respectively, the heat transfer fluid is brought into direct contact with the material being dried by circulating heat transfer fluid over, around or through said material. Heat exchange is therefore intimate by nature of contact. The heat transfer fluid, air in this example, not only conveys the energy required for evaporating the subject liquid, it is also responsible for transporting the evaporated gas and/or vapor away from the material being dried. By contrast, indirect-contact vapor recompression evaporative drying 128 depicted in FIG. 1.c uses the gas and/or vapor evaporating from the subject liquid as the heat transfer fluid 131, 133. However, notwithstanding the fact that the evaporate itself is employed as the heat transfer fluid, gas phase water in this example, it is not brought into direct contact with the material being dried. Instead, the heat transfer fluid 131, 133 is isolated from the material being dried by a heat exchanger 140 as shown in FIG. 1.c. As a result, heat transfer is not intimate, but rather indirect through the wall or walls of a heat exchanger placed under, next to or within the material being dried. Notwithstanding this distinction, the evaporative thermodynamic cycle is identical in all three cases as demonstrated by FIGS. 2.a and 2.b.

For the body of discussion to follow, the notation “T-s” equates to the function s on T, s(T), where

$$Δ s = {\int }_{A} d q / T ( q ) ,$$

A is the set defining the range of heat values considered, T is temperature in degrees Kelvin, dq=Cₚ∫dT, and Cₚ is specific heat at constant pressure.

FIG. 2.a is a qualitative temperature T versus entropy s (T-s) diagram 200 of water evaporating and then condensing at relative constant pressure. The T-s course 200 depicts the thermodynamic cycle of liquid evaporating in direct-contact heated air and direct-contact heat pump evaporative drying processes, reference FIGS. 1.a and 1.b, respectively. In this example, water is depicted as the subject fluid being evaporated from a material being dried, but any subject fluid would present a similar thermodynamic cycle. In the context of this disclosure, it is important to understand that the T-s course 200 shown in FIG. 2.a is that of the evaporating subject liquid, not the heat transfer fluid, and not the refrigerant used by a mechanical heat pump or other refrigeration cycle. The abscissa of the diagram 200 represents increasing entropy s, whereas the ordinate indicates increasing temperature T. Isobaric lines have been omitted for reasons of clarity. Liquid phase state is to the left of the saturated liquid line 202 and gas phase state is to the right of the saturated vapor line 204. Note that the T-s course 200 is demarcated by the following numerals: 1, 2, 3, 4, 4′, 5, 6, and 7. The demarcations 1-2-3-4 along the T-s course 200 generally encompass the evaporation process. The demarcations 4′-5-6-7 along the same course generally encompass the condensation process. The demarcations at points 1 and 7 along the T-s course depict a sub-cooled liquid phase state. The demarcation at point 4 and 4′ depict a superheated gas phase state.

For the following discussion, demarcation numerals 1 through 7 shown in FIG. 2.a may be correlated to demarcation numerals 1 through 7 in FIGS. 1.a and 1.b. In this way, the thermodynamic T-s cycle of the subject liquid evaporating and condensing as shown in FIG. 2.a may be positionally tracked in the flow diagrams in FIGS. 1.a and 1.b.

Referring to FIG. 2.a, water at some initial temperature and energy 1 is isobarically heated to its saturated liquid temperature 2. This occurs in the dryer 102 of FIG. 1.a and 124 of FIG. 1.b for example. Further heating causes isothermal phase change from saturated liquid 2 to saturated vapor 3. This evaporation process is also isobaric. Continued heating results in a measure of superheat as shown by the T-s course from 3 to 4. Superheat in this context means that the temperature of the evaporated vapor is raised somewhat above its saturated vapor temperature 3. This condition is often required in practice as a means to prevent condensation from occurring on machine parts and conveying ducts. For some traditional methods of evaporative drying, e.g. heated air evaporation, the gas phase evaporate is exhausted from the drier after T-s condition 4 is achieved. This would be the warm moist air 111 leaving the dryer 102 in FIG. 1.a for example. For other traditional methods of evaporative drying, e.g. heat pump, the evaporate is condensed back to liquid phase as a means to capture and reuse a fraction of its phase change energy. This is done to improve the energy efficiency of drying over that of once-through heated-air systems.

Referring still to FIG. 2.a, the T-s course 4′-5-6-7 generally encompasses the condensation cycle. Note the corresponding numerals 126 in FIG. 1.b. The demarcation point 4′ accounts for isentropic compression (reversible adiabatic) accomplished by the fan or blower 116 of FIG. 1.b. Superheated gas evaporate 4′ is isobarically cooled to its saturated vapor point 5 in the cold heat exchanger 118. Further cooling in 118 condenses the gas evaporate indicated by the isothermal line from saturated vapor 5 to saturated liquid 6. This condensation process is also isobaric. Continued cooling in 118 sub-cools the saturated liquid 6 to some lower temperature and entropy shown at demarcation point 7. This point in the thermodynamic cycle correlates to “7” 125 in FIG. 1.b for example. The condensation T-s course 4′→7 shown in FIG. 2.a is valid for direct-contact heated air evaporative drying 100 FIG. 1.a; however, it is completed in the atmosphere outside the drying system. Note the direction of heat flow indicated by the shaded arrow 209 (typical four places) from the heat source T₂ 208 during evaporation 210, versus the heat flow arrow 209 to the heat sink T₁ 206 during condensation 212. The temperature separation between isothermal evaporation 2→3 210 and isothermal condensation 5→6 212 has been exaggerated in FIG. 2.a for clarity. Polytropic processes such as entropy changes due to friction, non-adiabatic compression and expansion, and other irreversible energy processes are not depicted in the interest of simplifying the T-s diagram.

FIG. 2.b is a qualitative temperature T versus entropy s (T-s) diagram 220 of water evaporating and then condensing at relative different pressures. This T-s course 220 depicts the thermodynamic cycle of liquid evaporating and condensing in indirect-contact vapor recompression evaporative drying processes, reference FIG. 1.c. In this example, water is depicted as the subject fluid being evaporated from a material being dried, but any subject fluid would present a similar thermodynamic cycle. In the context of this disclosure, it is important to understand that the T-s course 220 is that of the evaporating subject liquid. It should also be understood that for vapor recompression evaporative drying, the gas and/or vapor evaporated from the material being dried is/are the heat transfer fluid. Admonitions cited for FIG. 2.a are valid and apply to FIG. 2.b.

For the following discussion, demarcation numerals 1 through 7 shown in FIG. 2.b may be correlated to the demarcation numerals 1 through 7 in FIG. 1.c. In this way, the thermodynamic T-s cycle of the subject liquid evaporating and condensing as shown in FIG. 2.b may be positionally tracked in the flow diagram in FIG. 1.c.

Referring to FIG. 2.b, water at some initial temperature and energy 1 is isobarically heated to its saturated liquid temperature 2. This occurs in the dryer 132 of FIG. 1.c for example. Further heating in 132 causes isothermal phase change from saturated liquid 2 to saturated vapor 3. This evaporation process is also isobaric. Continued heating in 132 results in a measure of superheat as shown by the T-s course from 3 to 4. The fluid is adiabatically heated by action of compression from the compressor 130, hence the isentropic course from 4 to 4′. For this traditional method of evaporative drying, i.e. vapor recompression, the gas and/or vapor phase evaporate is employed as the heat transfer fluid. Further, it is condensed with heat transfer to the material being dried as a means to capture and reuse a fraction of the phase change energy absorbed during evaporation. After compression, the evaporate is isobarically cooled to saturated vapor phase 5 in the heat exchanger 140. Further cooling in 140 results in isothermal phase change from saturated vapor 5 to saturated liquid phase 6. Continued cooling sub-cools the saturated liquid at 6 to some lower temperature and entropy shown at demarcation point 7. Note the direction of heat transfer indicated by the shaded arrows 230, and that heat energy is expelled by the evaporate condensing 232 on one side of the heat exchanger, while heat energy is being absorbed by the evaporate evaporating 234 on the other side of the heat exchanger. The temperature separation between isothermal evaporation 2→3 234 and isothermal condensation 5→6 232 has been exaggerated in FIG. 2.b for clarity. Polytropic processes such as entropy changes due to friction, non-adiabatic compression and expansion, and other irreversible energy processes are not depicted in the interest of simplifying the T-s diagram.

Although the amount of adiabatic heating 4→4′ by fan or blower compression is small for heat pump evaporative drying as compared to compressor compression used for vapor compression evaporative drying, the T-s cycles are otherwise identical. It should be noted at this point that polytropic processes associated with various irreversible energy changes are different in both magnitude and type (kind) for heat pump versus mechanical vapor recompression evaporative drying; however, these differences are inconsequential for the purpose of this disclosure.

The purpose of presenting the information depicted in FIGS. 1.a through 2.b as described above is to demonstrate that direct-contact heated-air, direct-contact heat pump and indirect-contact vapor recompression evaporative drying processes share a common thermodynamic cycle relative to the evaporation process itself. In the context of the embodiments of the present invention, it is important to understand and appreciate that all thermal evaporative drying processes share this common thermodynamic cycle regardless of drier category, type, kind, fuel type or material being dried. By contrast, binary fluid ejector desiccation employs heretofore unexploited operating principles for the purpose of thermal evaporative drying. Those skilled in the relevant art will understand and appreciate these distinctions from the drawings, diagrams, and discussions to follow.

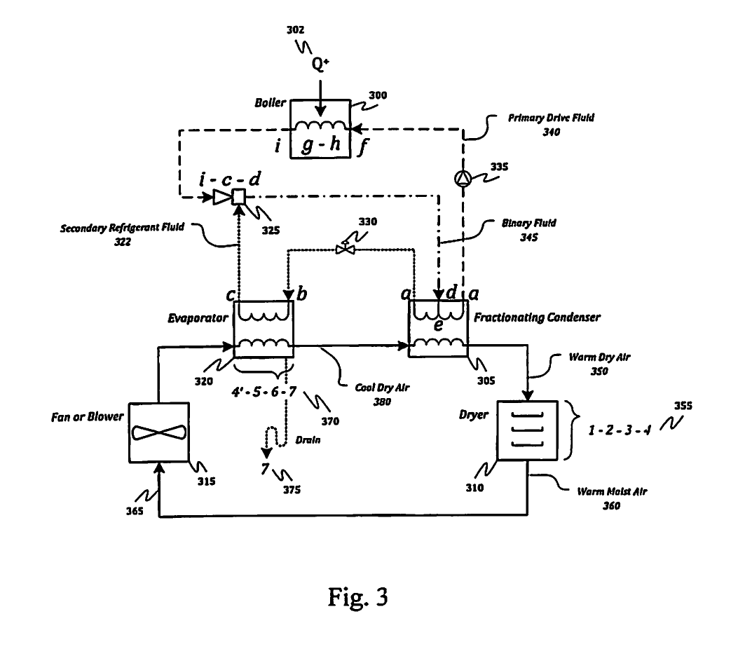

For the embodiments of the present invention, one method of use involves direct-contact evaporative drying as depicted in FIG. 3. The fluid circuit comprises binary fluid ejector refrigeration cycle coupled to a direct-contact evaporative drying cycle. The refrigeration circuit is comprised of a boiler 300, a fractionating condenser 305, an evaporator 320, a binary fluid ejector 325 (of the type previously disclosed in U.S. patent application Ser. No. 12/541,821, filed Aug. 14, 2009, which is incorporated herein for all purposes), an expansion valve 330 and a refrigerant pump 335. For sake of clarity, control and service valves and instrumentation are not shown. Fluid flow in the circuit is depicted by a dashed line denoting primary drive fluid 340, dashed-dotted line denoting binary fluid 345 and a dotted line denoting secondary refrigerant fluid 322. Arrows depict the direction of fluid flow. Any suitable binary fluid may be employed in this circuit, for example a hydrocarbon primary drive fluid working with water as a secondary refrigerant fluid. The drying circuit is comprised of a fan, blower or other suitable device 315, a dryer 310, a cold heat exchanger 320 (also the evaporator for the refrigeration cycle) and a hot heat exchanger 305 (also the condenser for the refrigeration cycle). Fluid flow in the drying circuit is depicted by a solid line, with cool dry air 380, warm dry air 350 and warm moist air 360 indicated accordingly. Arrows depict the direction of fluid flow. The heat transfer fluid depicted is air, but any suitable heat transfer fluid may be used. The two thermodynamic cycles, namely the binary fluid ejector refrigeration cycle and the direct-contact evaporative drying cycle, are thermodynamically coupled by the cold heat exchanger/evaporator 320 and hot heat exchanger/condenser 305. The working fluids in the two circuits are physically isolated from each other by the two heat exchangers 320 and 305. Notations 1 through 7 and a through i are discussed in more detail below.

Still referring to FIG. 3, thermal energy is input to the system at Q⁺ 302 by means of a heat exchanger such as a boiler 300. The thermal energy may be from any source, such as by example but not limited to flue gas, engine exhaust, process waste heat, geothermal energy or solar radiation. Heat energy Q⁺ 302 to drive the system may also be supplied by burning a fuel or utilizing electricity. Primary drive fluid 345 is vaporized under high pressure in the boiler 300. High pressure gas is then conveyed under pressure to the binary fluid ejector 325 where it entrains, mixes and compresses the secondary refrigerant fluid 322 evolving from the evaporator 320. Thermal energy required to evaporate the refrigerant fluid 322 is supplied through the cold heat exchanger/evaporator 320 by warm moist air 360 serving as the heat transfer fluid 365 circulating in the drying circuit. The binary fluid ejector 325 mixes the primary drive fluid 340 and the refrigerant fluid 322 thereby making it a binary fluid 345, and equilibrates it to some pressure intermediate between the evaporator 320 pressure and the boiler 300 pressure. The binary fluid 345 is conveyed under pressure to the fractionating condenser 305 where it condenses to liquid phase and is separated. The primary drive fluid 340 is conveyed back to the boiler 300 for reuse by liquid pump 335. The secondary refrigerant fluid 322 is conveyed under pressure back to the evaporator for reuse through the expansion valve 330 (also known as a throttling valve). Thermal energy released by the condensing binary fluid 345 is transferred through the hot heat exchanger/condenser 305 and absorbed by the cool dry air 380 serving as the heat transfer fluid for the drying circuit. The drying circuit is depicted by the solid arrowed lines 365.

Still referring to FIG. 3, warm dry air 350 serving as the heat transfer fluid for the evaporative drying cycle is conveyed to the dryer 310 by fan 315 where it is brought into direct intimate contact with the material being dried. Thermal energy required to evaporate the subject liquid from the material being dried is supplied by this warm dry air 350. After evaporation, warm moist air 360 is conveyed to the cold heat exchanger/evaporator 320 by fan 315. Thermal energy from the warm moist air 360 is transferred to the secondary refrigerant fluid 322 through the walls of the heat exchanger 320, and is thus cooled. Cool dry air 380 is conveyed from the cold heat exchanger 320 to the hot heat exchanger/condenser 305 by fan 315. Thermal energy is absorbed by the cool dry air 380 through the walls of the hot heat exchanger 305 from the condensing binary fluid 345, and is thus heated.

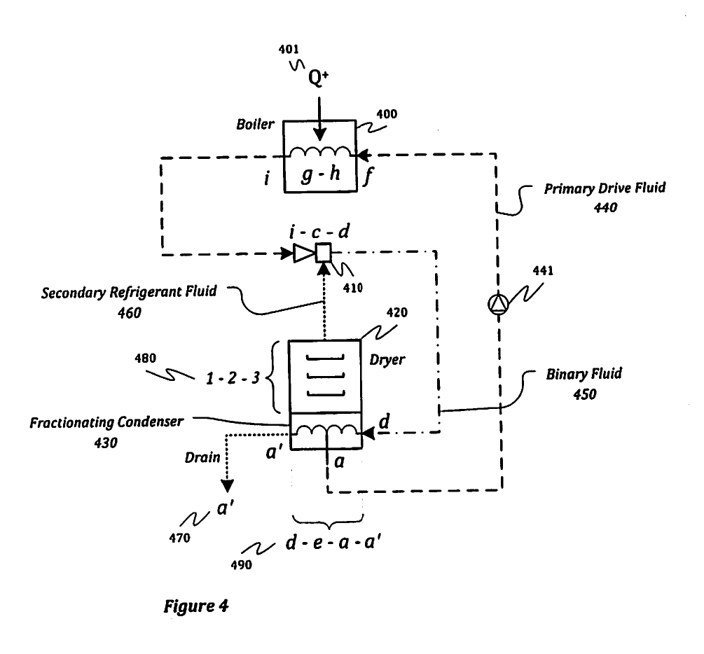

For the embodiments of the present invention, another method of use involves indirect-contact evaporative drying as depicted in FIG. 4. The fluid circuit comprises a binary fluid ejector refrigeration cycle coupled to an indirect-contact evaporative drying cycle. The refrigeration circuit and the evaporative drying circuit are intimately connected relative to this method of use. The system is comprised of a boiler 400, a binary fluid ejector 410, a dryer 420, a fractionating condenser 430 and a pump 441. For the sake of clarity, control and service valves and instrumentation are not shown. Fluid flow in the circuit is depicted by a dashed line denoting primary drive fluid 440, dashed-dotted line denoting binary fluid 450 and a dotted line denoting secondary refrigerant fluid 460. Arrows depict the direction of fluid flow. For this method of use, the gas phase evaporate from the material being dried serves as the secondary refrigerant fluid 460. Any suitable binary fluid may be employed in this circuit, for example a hydrocarbon primary drive fluid working with water as a secondary refrigerant fluid. Thermal energy is input to the system at Q⁺ 401 by means of a heat exchanger called a boiler 400. The thermal energy may be from any source, such as by example but not limited to flue gas, engine exhaust, process waste heat, geothermal energy or solar radiation. Heat energy Q⁺ 401 to drive the system may also be supplied by the burning a fuel or utilizing electricity. Primary drive fluid 440 is vaporized under high pressure in the boiler 400. High pressure gas 440 is then conveyed under pressure to the binary fluid ejector 410 where it entrains, mixes and compresses the secondary refrigerant fluid 460 evolving from the dryer 420. The secondary refrigerant fluid 460 is the gas and/or vapor evaporating from the subject liquid from the material being dried. Thermal energy required to evaporate the subject liquid from the material being dried is supplied through the fractionating condenser 430 by the binary fluid 450 condensing therein. At this point in the system, namely the wall or walls of the condenser 430 and the material being dried, the evaporating subject liquid and the condensing binary fluid 430 are physically separated by said wall or walls of the condenser heat exchanger 430. The binary fluid 450 is separated into its two fluid constituents within the fractionating condenser 430. Primary drive fluid constituent 440 is conveyed back to the boiler 400 for reuse by pump 441. The remaining fraction of the binary fluid 430 after separation is the distillate from the liquid evaporated from the material being dried, which is drained or pumped (not shown) from the system 470.

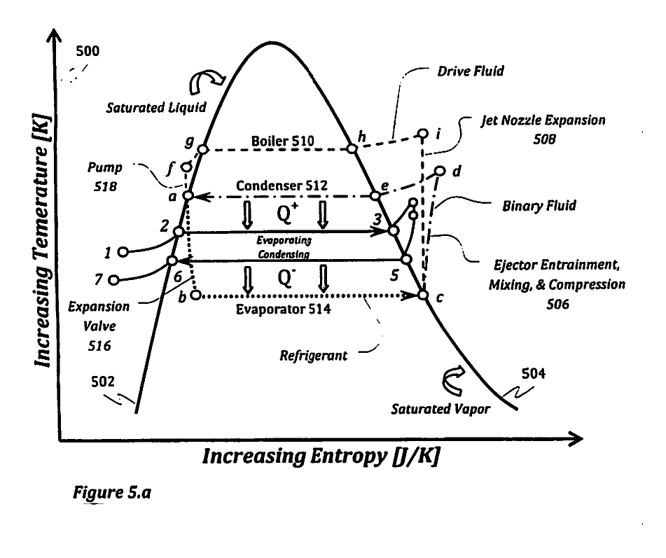

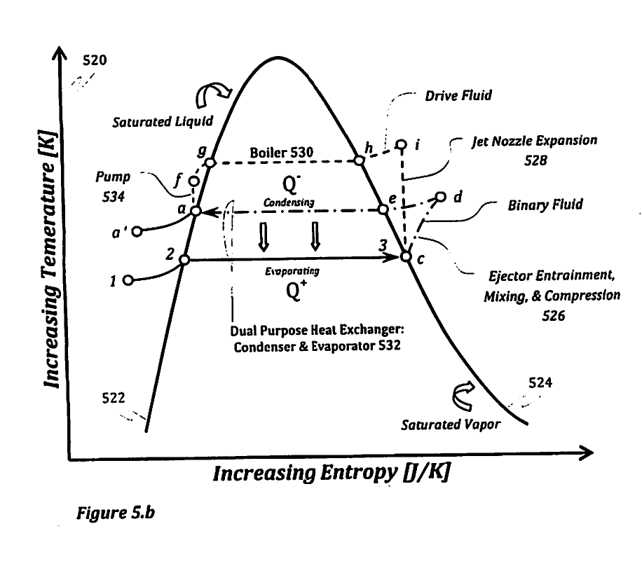

FIG. 5.a is a qualitative temperature T versus entropy s (T-s) diagram 500 of water evaporating and then condensing at relative constant pressures, coupled with the thermodynamic T-s course of the binary fluid and separated constituents employed by the binary fluid ejector refrigeration cycle. The T-s course 500 depicts the thermodynamic cycle of one method of use for the embodiments of the present invention herein referred to as direct-contact evaporative drying, reference FIG. 3. In this example, water is depicted as the subject fluid being evaporated from a material being dried, but any subject fluid would present a similar thermodynamic cycle. The abscissa of the diagram 500 represents increasing entropy s, whereas the ordinate indicates increasing temperature T. Isobaric lines have been omitted in the interest of making the diagram easier to interpret. Liquid phase state is to the left of the saturated liquid line 502 and gas phase state is to the right of the saturated vapor line 504. Note that the T-s course 500 is demarcated by numerals 1 through 7, associated with solid lines and arrows that denote the thermal cycle of the subject liquid being evaporated from the material being dried. The demarcations 1-2-3-4 along this course generally encompass the evaporation process of the subject liquid. The demarcations 4′-5-6-7 along the same course generally encompass the condensation process of the subject liquid. Note also that the T-s course is demarcated by letters a through i, associated with dashed, dashed-dotted and dotted lines with arrows that denote the thermal cycle of the binary fluid and separated fluid constituents.

For the following discussion, the demarcation numerals 1 through 7 and the letters a through i in FIG. 5.a may be correlated to similar numerals and letters on the flow diagram in FIG. 3. In this way, the thermodynamic cycle of the embodiments of the present invention termed herein as direct-contact evaporative drying representing one method of use may be accounted for and positionally tracked on its corresponding flow diagram of FIG. 3.

It is important to understand that from a conceptual point of view, the functioning thermodynamic cycle of the embodiments of the present invention comprises two thermodynamic cycles, one within the other, represented by the temperature-entropy course of the subject liquid evaporating and condensing, coupled with the temperature-entropy course of the binary fluid ejector refrigeration cycle. This view is valid for two reasons: 1) because neither the evaporative drying cycle nor the ejector refrigeration cycle can function independent of each other for this method of use; and 2) because the two thermodynamic cycles are physically coupled by the cold heat exchanger/evaporator 320 and the hot heat exchanger/condenser 305 as shown in FIG. 3. This is the rationale for the nomenclature “thermodynamic bi-cycle” as applied to the embodiments of the present invention.

Still referring to FIG. 5.a, secondary refrigerant fluid undergoes isenthalpic throttling through an expansion valve 516 as indicated by demarcations a→b. This is a non-isentropic process that increases entropy. This corresponds to notation a and b across the expansion valve 330 in FIG. 3 for example. Heat energy supplied by condensing gas and/or vapor from the material being dried evaporates the refrigerant isothermally from b→c. The refrigerant fluid is entrained, mixed and compressed by the binary fluid ejector 325 in FIG. 3 along the T-s path c→d; this mixture of primary and secondary fluids constitute the binary working fluid. The c→d process is near isentropic (reversible adiabatic compression), but some entropy is created. The binary fluid is then isobarically cooled in the condenser 305 in FIG. 3 to its saturated vapor state e. It is further cooled in 305, isothermally condensing from e→a. After separation by the fractionating condenser 305, the secondary refrigerant fluid is conveyed under pressure back to the expansion valve 330 for reuse in the evaporator 320, while the primary drive fluid is pumped by 335 to the boiler 300; this is indicated by the T-s course a→f accompanied by the notation pump 518. The primary drive fluid is isobarically heated from f→g to its saturated liquid state at g. Further heating causes the primary fluid to evaporate isothermally from g→h accompanied by the notation boiler 510. Continued heating raises its temperature isobarically to i, where it is then conveyed under pressure to the jet nozzle in the binary fluid ejector 325 shown in FIG. 3. Isentropic expansion occurs through the jet nozzle from i→c completing the cycle. For simplicity, polytropic processes associated with irreversible energy changes are not shown.

FIG. 5.b is a qualitative temperature T versus entropy s (T-s) diagram 520 of water evaporating and then condensing at relatively different pressures, coupled with the thermodynamic T-s course of the binary fluid and its separated constituents employed by the binary fluid ejector refrigeration cycle. This T-s course 520 depicts the thermodynamic cycle of another method of use for the embodiments of the present invention herein referred to as indirect-contact evaporative drying of FIG. 4. All admonitions cited for FIG. 5.a are valid for and apply to the T-s diagram depicted in FIG. 5.b. Demarcation numerals 1 through 3 and letters a through i in FIG. 5.b may be correlated to the numerals and letters cited on the flow diagram in FIG. 4 for the purpose of accounting for and tracking the thermal T-s cycle on the flow diagram.

It should be understood that for this method of use for the embodiments of the present invention, i.e. indirect-contact evaporative drying, the gas and/or vapor evaporated from the subject liquid from the material being dried serves as both the heat transfer fluid for the drier as well as the secondary refrigerant fluid for the binary fluid ejector refrigeration cycle. In this case, the subject evaporate is ingested by the binary fluid ejector 410 in FIG. 4, mixed with the primary drive fluid 440, and equilibrated as a binary working fluid 450. The binary fluid 450 is then circulated through a heat exchanger 430 which is in contact or otherwise in close proximity to the material being dried in the dryer 420. The heat exchanger serves 430 two purposes: 1) to condense the binary fluid, thereby releasing phase change energy; and 2) to evaporate the liquid from the material being dried, thereby absorbing the same phase change energy.

Still referring to FIG. 5.b, liquid from the material being dried is isobarically heated from 1 to saturated liquid state 2. The heat energy for this evaporation process is supplied by the binary fluid condensing along the T-s line e→a in heat exchanger 430 in FIG. 4. The evaporate from the material being dried is then ingested by the binary fluid ejector 410 at c, by which it is entrained, mixed and compressed along the T-s line c→d by action of high pressure primary drive fluid 440. The binary fluid is isobarically cooled in the heat exchanger 430 from superheated vapor state d to saturated vapor state e. Further cooling causes isentropic phase change from saturated vapor state e to saturated liquid state a. Heat energy release during this condensing phase change is transferred by heat exchanger 430 to the liquid evaporating from the material being dried, thereby reusing phase change energy. The binary fluid is fractionated and separated at phase state a. The subject evaporate is a condensed saturated liquid at a. Continued cooling sub-cools the condensate to a′, where it is drained or pumped from the system. Sensible heat energy released during this sub-cooling process is transferred to the liquid on/in the material being dried by heat exchanger 430, thus accounting for the isobaric heating of the subject liquid along the T-s line 1→2. After separation, primary drive fluid 440 is pumped 441 from saturated phase state a to some higher pressure f indicated by 534. The primary drive fluid is isobarically heated from f→g to its saturated liquid state at g. Further heating causes the primary fluid to evaporate isothermally from g→h along the T-s line indicated by 530. Continued heating raises its temperature isobarically to i, where it is then conveyed under pressure to the jet nozzle in the binary fluid ejector 410 in FIG. 4. Isentropic expansion occurs through the jet nozzle from i→c completing the cycle. For simplicity, polytropic processes associated with irreversible energy changes are not shown.

For one method of use termed herein as direct-contact evaporative drying, the thermodynamic cycle of the embodiments of the present invention depicted in FIG. 5.a and its counterpart flow circuit depicted in FIG. 3 represent art that is distinct from and superior to all direct-contact thermal evaporative drying means, methods and systems. Unlike conventional thermodynamic cycles, the thermodynamic cycle of the embodiments of the present invention comprises two cycles, one within the other, which is intimately connected by two heat exchangers serving the dual role of evaporator for an evaporative drying cycle and condenser for an ejector refrigeration cycle.

For another method of use termed herein as indirect-contact evaporative drying, the thermodynamic cycle of the embodiments of the present invention depicted in FIG. 5.b and its counterpart flow circuit depicted in FIG. 4 equally represent art that is distinct from and superior to all indirect-contact thermal evaporative drying means, methods and systems. Unlike conventional thermodynamic cycles, the thermodynamic cycle of the embodiments of the present invention is two cycles, one within the other, which is intimately connected by one heat exchanger serving a dual role of evaporator for an evaporative drying cycle and condenser for an ejector refrigeration cycle.

Although the invention has been described in detail with reference to several embodiments, additional variations and modifications exist within the scope and spirit of the invention as described and defined in the following claims.

I claim:

1. A system for thermally drying materials comprising:
a power source;
a first thermodynamic cycle comprising direct-contact heated-air facilitated by a heat pump, and means for vapor compression; and
a second thermodynamic cycle including a gas phase ejector configured to facilitate gas phase ejector refrigeration.

2. The system of claim 1 wherein said power source is one or more of the following: a heat flue gas, engine exhaust, solar radiation, process waste heat and/or geothermal energy.

3. The system of claim 1 wherein a primary drive fluid of the binary fluid ejector has a low phase change enthalpy relative to a secondary drive fluid resulting in an increased coefficient of performance of the refrigeration cycle.

4. The system of claim 3 wherein said primary drive fluid is one of the following: 2,3,-dihydrodeca-fluoropentane or C₅H₂F₁₀.

5. A system for thermally drying materials comprising:
a power source;
a first thermodynamic cycle comprising indirect-contact heated-air facilitated by a heat pump, and means for vapor compression; and
a second thermodynamic cycle including a gas phase ejector configured to facilitate gas phase ejector refrigeration.

6. The system of claim 5 wherein said power source is one or more of the following: a heat flue gas, engine exhaust, solar radiation, process waste heat and/or geothermal energy.

7. The system of claim 5 wherein a primary drive fluid of the binary fluid ejector has a low phase change enthalpy relative to a secondary drive fluid resulting in an increased coefficient of performance of the refrigeration cycle.

8. The system of claim 7 wherein said primary drive fluid is one of the following: 2,3,-dihydrodeca-fluoropentane or C₅H₂F₁₀.

9. A system for thermally drying materials comprising:
a power source;
a first thermodynamic cycle comprising direct-contact heated-air facilitated by a heat pump, and means for vapor compression; and
a second thermodynamic cycle including a gas phase ejector configured to facilitate gas phase ejector vapor recompression.

10. The system of claim 9 wherein said power source is one or more of the following: a heat flue gas, engine exhaust, solar radiation, process waste heat and/or geothermal energy.

11. The system of claim 9 wherein a primary drive fluid of the binary fluid ejector has a low phase change enthalpy relative to a secondary drive fluid resulting in an increased coefficient of performance of the refrigeration cycle.

12. The system of claim 11 wherein said primary drive fluid is one of the following 2,3,-dihydrodeca-fluoropentane or C₅H₂F₁₀.

13. A system for thermally drying materials comprising:
a power source;
a first thermodynamic cycle comprising indirect-contact heated-air facilitated by a heat pump, and means for vapor compression; and
a second thermodynamic cycle including a gas phase ejector configured to facilitate gas phase ejector vapor recompression.

14. The system of claim 13 wherein said power source is one or more of the following: a heat flue gas, engine exhaust, solar radiation, process waste heat and/or geothermal energy.

15. The system of claim 13 wherein a primary drive fluid of the binary fluid ejector has a low phase change enthalpy relative to a secondary drive fluid resulting in an increased coefficient of performance of the refrigeration cycle.

16. The system of claim 15 wherein said primary drive fluid is one of the following 2,3,-dihydrodeca-fluoropentane or C₅H₂F₁₀.

17. A system for thermally drying materials comprising:
a power source;
a first thermodynamic cycle comprising direct-contact heated-air facilitated by a heat pump, and means for vapor compression; and
a second thermodynamic cycle including a binary fluid ejector configured to facilitate binary fluid ejector refrigeration.

18. A system for thermally drying materials comprising:
a power source;
a first thermodynamic cycle comprising indirect-contact heated-air facilitated by a heat pump, and means for vapor compression; and
a second thermodynamic cycle including a binary fluid ejector configured to facilitate binary fluid ejector refrigeration.

19. A system for thermally drying materials comprising:
a power source;
a first thermodynamic cycle comprising direct-contact heated-air facilitated by a heat pump, and means for vapor compression; and
a second thermodynamic cycle including a binary fluid ejector configured to facilitate binary fluid ejector vapor recompression.

20. A system for thermally drying materials comprising:
a power source;
a first thermodynamic cycle comprising indirect-contact heated-air facilitated by a heat pump, and means for vapor compression; and
a second thermodynamic cycle including a binary fluid ejector configured to facilitate binary fluid ejector vapor recompression.

21. A system for thermally drying materials comprising:
a power source;
a thermodynamic cycle including a gas phase ejector configured to facilitate gas phase ejector refrigeration; and
means to capture, re-circulate and reuse a fraction of thermal energy produced by said thermodynamic cycle to facilitate an evaporative drying of subject materials.

22. A system for thermally drying materials comprising:
a power source;
a thermodynamic cycle including a binary fluid ejector configured to facilitate binary fluid ejector refrigeration; and
means to capture, re-circulate and reuse a fraction of thermal energy produced by said thermodynamic cycle to facilitate an evaporative drying of subject materials.

23. A system for thermally drying materials comprising:
a power source;
a thermodynamic cycle including a gas phase ejector configured to facilitate gas phase ejector vapor recompression; and
means to capture, re-circulate and reuse a fraction of thermal energy produced by said thermodynamic cycle to facilitate a vapor recompression evaporative drying of subject materials.

24. A system for thermally drying materials comprising:
a power source;
a thermodynamic cycle including a binary fluid ejector configured to facilitate binary fluid ejector vapor recompression; and
means to capture, re-circulate and reuse a fraction of thermal energy produced by said thermodynamic cycle to facilitate a vapor recompression evaporative drying of subject materials.
